(19) United States
(12) Patent Application Publication
(10) Pub. No.: US 2004/0171359 A1
(43) Pub. Date: Sep. 2, 2004

(54) Power allocation in a communication system

(76) Inventors: Olav Tirkkonen, Helsinki (FI); Pirjo Pasanen, Vantaa (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/632,089

(22) Filed: Aug. 1, 2003

Related U.S. Application Data
(60) Provisional application No. 60/450,328, filed on Feb. 28, 2003.

(51) Int. Cl. H04B 1/00

(52) U.S. Cl. 455/127.1

(57) ABSTRACT

A communication system, in which bit loading and power allocation are addressed, transfers data between a transmitter and a receiver over a plurality of channels. The system comprises modulation circuitry having a plurality of different modulation alphabets thereby providing a set of possible bit loading sequences. The system also has circuitry for determining the power to be allocated for each bit loading sequence based on minimizing the error rate and circuitry for selecting the bit loading sequence with the lowest error rate.

### CROSS-REFERENCE TO RELATED APPLICATIONS

This application claims priority of U.S. Provisional Patent Application Serial No. 60/450,328 entitled, “Power Allocation in a Communication System,” filed Feb. 28, 2003, the entire contents of which are incorporated herein by reference.

### BACKGROUND OF THE INVENTION

1. Field of the Invention

The present invention is concerned with wireless communication systems and in particular but not exclusively with communication systems for transferring data between a transmitter and a receiver over a plurality of channels.

2. Description of the Related Art

The need for techniques and systems that are able to support increased data rates are important in modern communication systems. One way of increasing the system capacity is to use a Multiple-Input, Multiple-Output (MIMO) system, which consists of multiple transmitting antennas and multiple receiving antennas. That is, in a MIMO system comprising one user, the user signal can be distributed between the transmitting antennas, and sent to the multiple receiving antennas. Therefore the benefit of a MIMO system is that by combining data in certain ways at the transmitting end and at the receiving end the overall quality (bit error rate—BER) or capacity (bit rate) of the system can be improved.

One of the characteristics central to any wireless communication system is the so-called multipath fading effect, which results in constructive and destructive interference effects being produced due to multipath signals. That is, a transmitted signal may develop a plurality of secondary signals which bounce off or are delayed by certain media, for example buildings, and result in multiple signal paths being created and received.

Whereas traditional single antenna systems suffer from multipath fading, MIMO systems use the random fading effect to improve the capacity of the channel by improving the spectral efficiency. By introducing a plurality of independent paths between the transmitter and receiver, the effects of poor channel conditions can be alleviated and the so-called “diversity” of the system is improved.

FIG. 1 shows a typical MIMO system comprising a transmitter 2 having Nₜ transmitting antennas and a receiver 6 having Nᵣ receiving antennas, which transfer data over the radio channel 4. The transmitter 2 is shown to comprise a coding unit 12 for receiving the incoming data stream 8 to be transmitted. The coding unit 12 acts to encode data, using for example certain FEC (Forward Error Correction) codes to mitigate errors caused by noise N₀ introduced when transmitting over the radio channel 4. The coding unit may also comprise functionality for interleaving bits to mitigate problems caused by bursts of noise data.

The coded signals are sent to a modulator 14, wherein the encoded bits are converted into complex value modulation symbols using particular modulation alphabets, for example QPSK (Quadrature Phase Shift Keying) or QAM (Quadrature Amplitude Modulation). Certain modulation alphabets are better suited for different channel conditions or system requirements. Therefore, adaptive modulation, that is where the modulation alphabet changes, is especially beneficial in fading channels of MIMO systems.

The modulated signals are sent to a weighting unit 16, which performs beamforming and determines weighting factors to allocate power to be transmitted by each of the transmitting antennas as described in more detail later.

The signals are then sent over the MIMO channel 4 to the receiving unit 6, which has inverse weighting 18, demodulation 20 and decoding 22 functionality for recovering the transmitted data stream.

A possible number of Nₜ*Nᵣ communication channels exist over the radio interface, each channel having its own channel characteristics, and from which a channel matrix H can be determined using for example a known training sequence in a known manner. In some other standards, training sequences are known as pilot sequences. As far as embodiments are concerned, any sequence of data known at the transmitting and the receiving end can be used.

Using mathematical manipulations such as singular values or eigenvalues, it is possible to determine the eigenmodes of the system, i.e. how many independent effective channels exist in the system. The independent effective channels can be used to transmit parallel data streams as shown in FIG. 2. That is, the MIMO channel 4 between the transmitter 2 and the receiver 6 can be decoupled into a plurality of parallel independent sub-channels (eigenmodes).

The MIMO system of FIG. 1 is shown as having Nₜ transmit antennas and Nᵣ receive antennas, the channel matrix H can be decomposed using SVD (singular value decomposition) into the product of three matrices as:

H=U^{H}ΣV Equation (1)

where U^{H} is the complex conjugate of a Nₜ×Nₜ unitary matrix, V is a Nᵣ×Nᵣ unitary matrix and Σ is a Nₜ×Nᵣ matrix whose elements are all zero except for the main diagonal having min(Nₜ, Nᵣ) singular values. Alternatively, the channel correlation matrix represented by H^{H}H may be eigenvalues decomposed as:

H^{H}H=V^{H}ΛV, Equation (2)

where Λ=Σ² is a diagonal matrix having Nₜ eigenvalues λᵢ of the channel correlation matrix on the main diagonal.

Beamforming is another technique used in MIMO systems, which can be used at either the transmitter or receiver antennas, for concentrating the energy of certain channels. For example, by applying power weighting factors to each of the transmitting antennas depending on their estimated channel quality, it is possible to optimize the capacity or performance of the system as a whole.

So in an MIMO system having reliable channel information, for example TDD (Time division Duplexing), or FDD (Frequency Division Duplexing) with reliable feedback, one may assume that the transmitter 2 has near perfect knowledge of the H matrix (i.e. the eigenvalues and eigenvectors) and noise power spectral density Nₒ. In this embodiment, the preferred strategy is to perform beamforming to set up at most min (Nₜ, Nᵣ) eigenbeams as shown in FIG. 2, which are orthogonal beams that do not interfere with one another at all.

In the past, the so-called technique of water-filling was used to maximize the system capacity by determining the optimal power applied as a weighting factor to each of the eigenmodes. This technique relies to a large extent on the theoretical limitations of Shannon coding theory, so that for maximum overall capacity, each eigenmode i has the power weighting factor Pᵢ determined by:

$${P}_{i} = {( µ - \frac{{N}_{0} \cdot Ws}{2 {λ}_{i}} )}^{+} \qquad Equation ( 3 )$$

where W_{S} is the Shannon channel bandwidth, λᵢ is the eigenvalue for the i^{th} eigenmode of the H matrix, μ is the Lagrange multiplier (i.e. water level) which should be chosen such that the total power is not exceeded (i.e. ΣᵢPᵢ=P), and wherein the Kuhn-Tucker boundary conditions ensure that no beams are allocated negative power (i.e. Pi>0).

Since the basic idea behind water filling is to send more information through better channels, not only is a stronger power weighting factor Pᵢ applied to better channels, but also so-called “bit loading” is implicit in water filling solutions because more bits will be allocated to the stronger channels.

Although the water filling approach does take into account the system capacity, the disadvantage is that it does not take into account the impact on performance (i.e. the bit error rate) of different modulation methods that might be used. Typically only a few different symbol modulations can be used, so not all bit rates are possible.

Instead, a known method for optimizing performance is proposed by Hemanth Sampath and Arogyaswami Paulraj in their paper titled “Joint Transmit and Receive Optimization for High Data Rate Wireless Communication using Multiple Antennas” published in IEEE Proc. Asilomar 1999, Vol. 1 page 215-219 which is hereby incorporated by reference. The idea being that a symbol in a given modulation alphabet, for example QPSK, is transmitted on each eigenmode and power is allocated so that a linear mean-square error metric (MSE) is minimized. This leads to inverse water filling in that weaker eigenmodes are allocated more power and vice versa. Inverse water filling is especially evident in the high signal to noise ratio (SNR) region.

Minimization of the MSE means that the errors made in symbol detection are minimized (i.e. MMSE is the minimum mean-square error). However, symbol detection errors do not directly translate into BER's (bit error rates). When different modulation symbols are used for different spatial eigenmodes, minimizing the total symbol error will lead to suboptimal bit error rates. For example, if a 16-QAM symbol is used for the first eigenmode λ₁ and QPSK for λ₂ then applying MSE minimization leads to a solution where errors in 16-QAM symbols are as likely to occur as errors in QPSK symbols. Since the number of bits in the symbols are not equal, this is not an optimal solution in terms of BER.

Another reference proposed by Anna Scaglione, Petre Stoica, Sergio Barbarossa, Georgios B. Giannakis and Hemanth Sampath in their paper titled “Optimal designs for space-time linear precoders and decoders” published in IEEE Transactions on Signal Processing, Vol. 50 no. 5 of May 2002; discusses several different optimization methods. In addition to MMSE they design an optimization method which indirectly optimizes the BER in a situation where all the symbols use a particular modulation alphabet. This is disadvantageous because, as discussed, it is often beneficial for fading channels to have adaptive modulation, wherein the modulation alphabet changes.

### SUMMARY OF THE INVENTION

It is an aim of the embodiments of the present invention to address at least one or more of the problems discussed previously.

According to one aspect of the present invention, a communication system for transferring data between a transmitter and a receiver over a plurality of channels is provided. The system comprises modulation circuitry having a plurality of alphabets providing a set of bit loading sequences; circuitry for determining a power allocation for each bit loading sequence based on minimizing the error rate; and circuitry for selecting the bit loading sequence with the lowest error rate.

According to one of the preferred embodiments, the channels are independent logical channels decomposed from a MIMO channel.

In an alternative embodiment, the channels are independent logical channels decomposed from an Orthogonal Frequency Division Multiplexing (OFDM) channel.

According to another embodiment of the invention a method for transferring data between a transmitter and receiver over a communication channel is provided. The method comprises the steps of identifying a set of bit loading sequences from a plurality of modulation alphabets; determining a power allocation for each bit loading sequence based on minimizing the error rate; and selecting the bit loading sequence with the lowest error rate and applying the power allocation to at least one communication channel.

According to a further embodiment of the present invention, a communication system for transferring data between a transmitter and receiver over a communication channel is provided. The system comprises circuitry for decomposing the communication channel into a plurality of logical channels. The system comprises modulation circuitry having a plurality of alphabets, each capable of representing the data using a different number of bits so that for a fixed data rate a set of bit loading sequences is identified which specify the number of bits to be loaded onto each of the logical channel. The system comprises circuitry for allocating a power weighting to each logical channel for minimizing a bit error rate of each of the identified bit loading sequences; and circuitry for choosing the bit loading sequence with the minimum bit error rate.

According to yet a further embodiment of the invention, a method for transferring data between a transmitter and receiver over a communication channel is provided. The method comprises a step of decomposing the communication channel into a plurality of logical channels. The method comprises a step of selecting from a plurality of alphabets to modulate the data, each capable of representing the data using a different number of bits. The method comprises a step of identifying a set of bit loading sequences for a fixed data rate which specify the number of bits to be loaded onto each of the logical channels. The method further comprises the steps of allocating a power weighting to each logical channel for minimizing a bit error rate of each of the identified bit loading sequences; and choosing the bit loading sequence with the minimum bit error rate.

### BRIEF DESCRIPTION OF THE DRAWINGS

Embodiments of the present invention will now be described by way of example only with reference to the accompanying drawings, in which:

FIG. 1 shows a MIMO system with which embodiments of the invention can be used;

FIG. 2 shows independent eigenmodes embodying the invention; and

FIG. 3 shows systematic bits being distinguished from parity bits.

### DETAILED DESCRIPTION OF THE PREFERRED EMBODIMENTS

In one embodiment of the invention, the MIMO channel is decomposed into a number of substantially independent logical channels, which can be used to transmit independent data streams.

However, in an alternative embodiment an OFDM system can be used. Broadly speaking OFDM relates to dividing the total available bandwidth into sub-channels with sufficient frequency separation so that they do not interfere and so that independent data streams are transmitted on each sub-channel. In this way, the frequency subcarriers (sub-channels) act automatically as frequency eigenmodes, i.e. substantially independent logical channels, as is the case with the MIMO embodiment. By having channel state information at the transmitter pertaining to the relative strength of these logical channels (i.e. the eigenvalues of the eigenmodes), bit loading and/or power allocation can be performed over these channels.

Although, the MIMO and OFDM embodiments have been described, it should be appreciated that other embodiments having multiple simultaneously available channels can also be used. The principle being that these channels can be separated either in the space direction (for example, using multiple separate antennas such as MIMO), in the frequency direction (for example, using frequency division multiplexing such as FDM), in the time direction (for example, TDM); or any combination of these or some other system wherein the channels can be separated.

In a restricted set of discrete modulation alphabets and a given number of eigenmodes, there is a restricted set of possible ways of loading the bits to the eigenmodes.

In general, the bit rate at which data is to be transmitted will vary depending on the channel conditions and several other factors. To determine the bit rate, a rough CQI (Channel Quality Indicator) calculation is performed in a TDD (Time Division Duplex) system at the transmitter 2; or alternatively in a FDD (Frequency Division Duplex) system at the receiver 6 to be fed back to transmitter. The CQI takes into account the eigenvalues λᵢ, and can be based on various condition numbers, i.e. different ratios of the eigenvalues.

Based on the CQI, the quality of service (Quos) requirements and/or the possible service class of the user the transmitter decides on the bit rate to be transmitted. There is a fixed set of possible bit loading sequences corresponding to the chosen bit rate. This selection may be restricted further by using some prior-knowledge. For example, in a strongly correlated channel, generally one eigenmode is large and the remaining eigenmodes are weak. Therefore, in one embodiment, the bit loading sequences that load bits on the weak eigenmodes may be automatically discarded.

In relation to the CQI's, it should be appreciated that there are many different ways of characterizing a channel (i.e. MIMO or OFDM). The most complete way would be to specify all the eigenvalues, but when there are many independent channels this can lead to very large LUT's (Look-Up Tables). For example, if the eigenvalues are quantized so that they each have 20 different CQI values, then a table of size 20⁴=160,000 would be needed for a 4×4 antenna MIMO. Therefore, in alternative embodiments, it may be preferable to use approximate CQI's.

Having determined a fixed bit rate and a finite number of allowed bit loading sequences, it is necessary to determine the optimal power allocations and bit loading on each eigenmode.

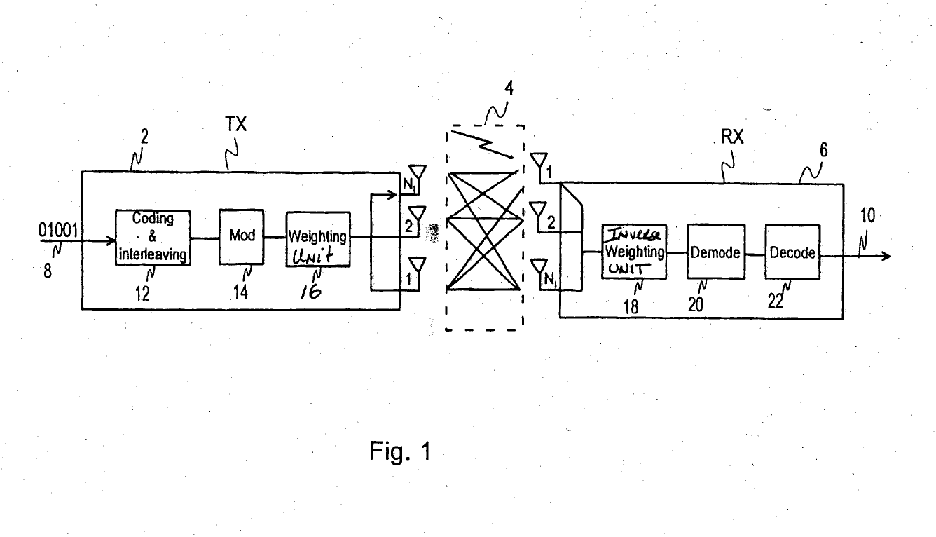

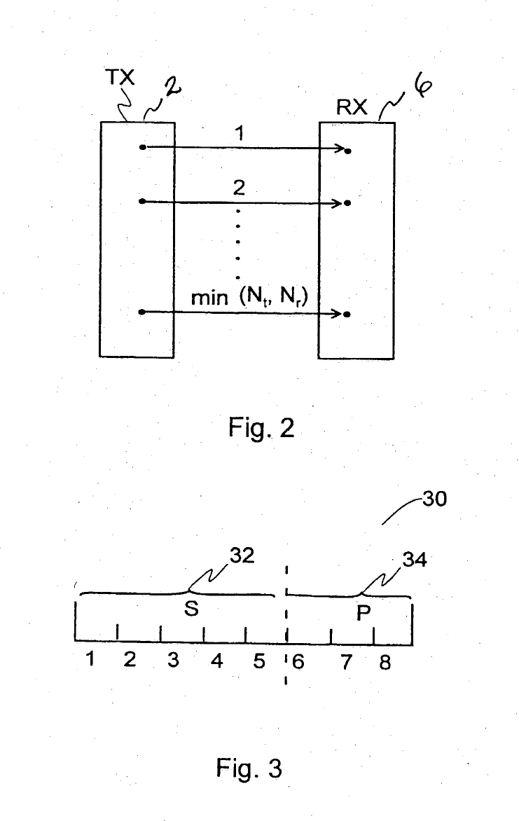

As an example, consider the MIMO system as shown in FIG. 1 where Nₜ=Nᵣ=4, so that there are four eigenmodes, and take the set of modulation alphabets to be 16-QAM (4 bits), QPSK (2 bits) and “no transmission” (0). If we restrict only to bit loading sequences with total of eight bits the possible bit loading sequences are

1) 4,4,0,0

2) 4,2,2,0

3) 2,2,2,2

Here the eigenmodes are ordered in a descending order, i.e. λ₁≧λ₂≧λ₃≧λ₄, so more bits are loaded to the stronger modes.

Corresponding to the ordered eigenmodes λ₁, λ₂, λ₃, λ₄ are power allocation weighting factors ω₁,ω₂,ω₃,ω₄. The weighting factors ωᵢ are normalized so that the average power per transmitted bit E_{b} is the same in the different modulation alphabets. Thus the 16-QAM modulation symbols would have twice the average power 2 of the QPSK modulation symbols. This means that for the 16-QAM/QPSK sequences considered, there is the power constraint:

Σbⱼωⱼ=8, Equation (4)

where bⱼ is the number of bits loaded on the eigenmode λⱼ. This is a power constraint which guarantees that the total transmit power of different bit loading sequences with different power allocations is the same.

The optimal power allocation can be derived by finding the minima of the bit error probabilities with respect to ωᵢ, subject to power constraints.

The average BER of a QPSK symbol, in a channel characterized by λᵢ, can be written as

P_{QPSK}(λᵢωᵢE_{b}/N₀)=Q(\sqrt{2λᵢωᵢE_{b}/N₀}) Equation (5)

To find the optimal weights between two QPSK symbols with power constraint ω₁+ω₂=2, take the derivative of P_{QPSK}(λ₁ω₁E_{b}/N₀)+P_{QPSK}(λ₂(2−ω₁)E_{b}/N₀) with respect to ω₁ and set it to zero. This gives the following equations:

ω₁+ω₂=2

$$\sqrt{\frac{{λ}_{1}}{{ω}_{1}}} {exp}^{- 2 {E}_{b} / {N}_{0} {λ}_{1} {ω}_{1}} = \sqrt{\frac{{λ}_{2}}{{ω}_{2}}} {exp}^{- 2 {E}_{b} / {N}_{0} {λ}_{2} {ω}_{2}} \qquad Equation ( 6 )$$

These equations may be difficult to solve analytically, but for all practical purposes they can be closely approximated by

λ₁ω₁=λ₂ω₂ Equation (7)

For two 16-QAM symbols the formulae are more complex, but the same approximation is still accurate. Therefore, near-optimal BER may be achieved when the received SNRs for the eigenmodes with the same symbols are made equal. Note that in this case the MMSE power allocation and BER optimal power allocation are equal at high SNR values.

In contrast, for nonhomogeneous modulations (i.e. when different modulation symbols are used in a bit loading sequence) the power allocation needs to be determined based on minimizing the total BER.

For example, in the 4,2,2,0 bit loading sequence above, the ratio of ω₁ and ω₂ may be determined so that the 16-QAM symbol transmitted on the strongest eigenmode may have approximately the same average performance as the QPSK symbols transmitted on eigenmodes λ₂ and λ₃.

According to these principles, the near optimal power allocation for the bit loading sequences of the example is performed as follows:

1) For the 4,4,0,0 BL sequence,

$$\frac{{ω}_{1}}{{ω}_{2}} = \frac{{λ}_{1}}{{λ}_{2}} \qquad Equation ( 8 )$$

Furthermore, the power constraint in Equation (4) dictates that ω₁+ω₂=2. This gives directly

$${ω}_{1} = \frac{2 {λ}_{2}}{{λ}_{1} + {λ}_{2}} , {ω}_{2} = \frac{2 {λ}_{1}}{{λ}_{1} + {λ}_{2}} \qquad Equation ( 9 )$$

The average BER is then

$$\begin{matrix}{P}_{4400} = {P}_{16 QAM} ( {λ}_{1} {ω}_{1} {E}_{b} / {N}_{0} ) \\ = {P}_{16 QAM} ( \frac{2 {λ}_{1} {λ}_{2}}{{λ}_{1} + {λ}_{2}} {E}_{b} / {N}_{0} )\end{matrix} \qquad Equation ( 10 )$$

2) For example, in the 4,2,2,0 bit loading sequence above, the weights of the two middle eigenmodes with equal numbers of bits are solved:

$$\frac{{ω}_{2}}{{ω}_{3}} = \frac{{λ}_{3}}{{λ}_{2}} \qquad Equation ( 11 )$$

Thus the BERs of the QPSK symbols transmitted on eigenmodes λ₂ and λ₃ are the same. The power constraint in Equation (4) now dictates

$$2 {ω}_{1} + ( 1 + \frac{{λ}_{2}}{{λ}_{3}} ) {ω}_{2} = 4 \qquad Equation ( 12 )$$

The optimal power allocation between the 16-QAM symbol and the QPSK symbols can be found by minimizing

P_{16QAM}(λ₁ω₁E_{b}/N₀)+P_{QPSK}(λ₂ω₂E_{b}/N₀) Equation (13)

with respect to ω₁ and ω₂, subject to Equation (12). Since the average BER of a 16-QAM symbol is rather more complicated than that of QPSK

$${P}_{16 QAM} ( {E}_{b} / {N}_{0} ) = \frac{3}{4} Q ( \frac{2}{\sqrt{5}} \sqrt{{E}_{b} / {N}_{0}} ) + \\ \frac{1}{2} Q ( \frac{6}{\sqrt{5}} \sqrt{{E}_{b} / {N}_{0}} ) - \frac{1}{4} Q ( \frac{10}{\sqrt{5}} \sqrt{{E}_{b} / {N}_{0}} ) \qquad Equation ( 14 )$$

analytical solutions for the minimization problem become less practical.

An approximate solution, valid at a high SNR, can be found by omitting the two last terms in Equation (14), and finding the zero of the derivative of Equation (13), subject to Equation (12). Thus it is sufficient to solve

$$\frac{2 {λ}_{2} {λ}_{3} ( 2 - {ω}_{1} )}{{λ}_{2} + {λ}_{3}} {E}_{b} / {N}_{0} - \frac{2}{5} {λ}_{1} {ω}_{1} {E}_{b} / {N}_{0} = ln \frac{2 \sqrt{10}}{3} + \frac{1}{2} ln \frac{{λ}_{2}}{{λ}_{1}} + ln \frac{2 {λ}_{3}}{( {λ}_{2} + {λ}_{3} )} + \frac{1}{2} ln \frac{{ω}_{1} ( {λ}_{2} + {λ}_{3} )}{2 {λ}_{3} ( 2 - {ω}_{1} )} \qquad Equation ( 15 )$$

or a linearized version of Equation (15) by omitting the last logarithm (i.e. the term

$$( i . e . the term \frac{1}{2} ln \frac{{ω}_{1}}{{ω}_{2}} )$$

on the right-hand side. It can be proved numerically that the linearized version, or even setting the right-hand side to zero, results in very good approximations of the optimal solution.

The average BER is then

$${P}_{4220} = \frac{1}{2} {P}_{16 QAM} ( {λ}_{1} {ω}_{1} {E}_{b} / {N}_{0} ) + \\ \frac{1}{2} {P}_{QPSK} ( {λ}_{2} {ω}_{2} {E}_{b} / {N}_{0} ) \qquad Equation ( 16 )$$

where ω₁,ω₂ are solved above in terms of λⱼ.

3) For example in the 2,2,2,2 bit loading sequence above,

λ₁ω₁=λ₂ω₂=λ₃ω₃=λ₄ω₄ Equation (17)

subject to the power constraint Σωⱼ=4. The optimal weights are now

ωⱼ=s/λⱼ, Equation (18)

where

$$s = \frac{4 {λ}_{1} {λ}_{2} {λ}_{3} {λ}_{4}}{{λ}_{1} {λ}_{2} {λ}_{3} + {λ}_{1} {λ}_{2} {λ}_{4} + {λ}_{1} {λ}_{3} {λ}_{4} + {λ}_{2} {λ}_{3} {λ}_{4}} \qquad Equation ( 19 )$$

The average BER is:

P₂₂₂₂=P_{QPSK}(λ₁ω₁E_{b}/N₀) Equation (20)

After the optimal power allocation for all possible bit loading sequences is determined, the sequence with the best performance is chosen (i.e. the bit loading sequence having the lowest BER).

Thus the choice of bit loading sequence depends on the channel, characterized by the eignemodes λ₁,λ₂,λ_{3,λ}₄. In our example, the bit loading sequence having the smallest BER of P₄₄₀₀,P₄₂₂₀,P₂₂₂₂ is chosen, and the bits are transmitted according to this, using the optimal power allocation weights calculated for the relevant bit loading sequence having the lowest BER.

For slow moving mobile station users, the power allocation and bit loading may be performed on a frame-to-frame basis. In this case, fairly complex calculations to determine the optimum power allocation and bit loading can be used.

However, linear approximations of some of the calculations produce very good results and may be used even if there are imperfections from the feedback channel state information.

For faster moving mobile users, with reallocation of channels required on a slot-to-slot (or OFDM symbol-to-symbol) basis, complexity becomes an issue. For practical application a look-up table may be constructed, where the optimal bit loading and power allocation information for a given channel's conditions is collected.

The disclosed power allocation and bit loading method may be used in conjunction with any set of modulation alphabets and in particular, with any concatenated channel code with or without bit/symbol/coordinate interleaving. The bit loading and power allocation may be optimized depending on the possible channel code. The power allocations and bit loading described thus far do not distinguish between the bits of the bit loading sequence in that all bits are treated equally. This is optimal if there is no channel code, or it the channel code applies to maximum likelihood (ML) decoding; for example a convolutional code with Viterbi decoding.

However, modern codes with near Shannon limit performance, for example turbo, low-density parity check (LDPC) and zigzag codes, apply iterative decoding, which operates algorithmically very differently from ML, although reaching near ML performance. Iterative decoding treats different bits in a different way. It is known that errors in the systematic bits affect performance more than errors in parity bits. Therefore, an alternative embodiment optimizes the power allocation and bit loading by distinguishing between bits and treating them accordingly.

For example, FIG. 3 shows an embodiment in which the systematic bits 32 are distinguished from the parity bits 34. Referring to FIG. 1, the coding unit 12 will add parity bits 34 to the systematic bits 32 which comprise chunks of the data stream 8 to be transferred. The receiver 6 then has functionality to distinguish between the actual system bits 32 and the parity bits 34.

As an example, consider a rate ¾ turbo code, pertinent for high-speed downlink packet access (HSDPA). ¾ of the bits are systematic, and ¼ are parity bits. In the example this means that out of the eight bits loaded, two are parity bits. These should preferably be mapped either to the QPSK symbols in the weaker eigenmodes, or to the least-significant bits of 16-QAM symbols. For each of the bit loading sequences in the example, this may be solved as follows:

1. For the 4, 4, 0, 0 bit loading sequence, the parity bits are loaded into the least significant bits of the four bits (of the 16-QAM symbol) loaded onto the weaker eigenmode λ₂. Furthermore in another embodiment, power allocation for the parity bits can be diminished, for example in the 4,4,0,0 case so that the average performance of the most significant bits on λ₂ equals the average performance of all bits on λ₁ (i.e. the 16-QAM symbol on the strongest eigenmode).

2. For the 4, 2, 2, 0 bit loading sequence, the parity bits are transmitted in the QPSK symbol on λ₃ and the power allocation for this symbol is diminished. In another embodiment, the parity bits are transmitted on the least significant bits of the 16-QAM symbol on λ₁ and power allocation is performed so that the average performance (BER) of all the systematic bits 32 is approximately equal. With the parity bits transmitted on the least significant bits of 16-QAM, the most significant bits in this 16-QAM act like a QPSK symbol with additional noise due to the parity bits. The systematic bits are thus effectively transmitted on three QPSK symbols. Equation (7) states that an approximate BER optimum for allocating power onto QPSK symbols is when the BER of the bits in each symbol is the same. Thus the expected BER of all the systematic bits, whether mapped on most significant 16-QAM or QPSK, should be about the same. The eigenvalue spread (i.e. difference in magnitude between the strengths of the respective eigenmodes) will determine, which embodiment is better suited for the system at any instant in time.

3. For the 2, 2, 2, 2 bit loading sequence, the parity bits 34 are transmitted on the QPSK symbol on λ₄ and the power allocation for this symbol is again diminished.

For each of the sequences described above a number of different ways of bit loading and power allocation were determined for mapping the coded (systematic and parity) bits. Each of these sequences results in a particular bit-error rate for the systematic bits (BERₛ), and a bit-error rate for the parity bits (BERₚ). Therefore, the BER of the coded bits (after decoding) can be approximated as a function of BERₛ and BERₚ. The bit loading and power allocation sequence that provides the smallest coded BER is chosen. This decision may be simplified by using a look-up table.

It should be appreciated that the coding, modulation and weighting functionality associated with the transmitting 2 and receiving elements 6 need not be implemented by individual units as shown in FIG. 1.

Embodiments of the invention can be used in any suitable wireless system having multiple transmitters at one end and multiple receivers at the other end. The transmitters may be provided by single antennas or each transmitter may be provided by an array of antennas.

Embodiments of the invention may be used in conjunction with feedback information pertaining to the channel state. The feedback information may be provided by the receiver to the transmitter, using a feedback channel. Any feedback method may be applied, including phase, amplitude, eigenvalue, long-term (correlation), perturbative or differential feedback.

Embodiments of the invention may be employed in conjunction with any standard or any access method such as Code Division Multiple Access, Frequency Division Multiple Access, Time Division Multiple Access, Orthogonal Frequency Division Multiple Access, or any other spread spectrum techniques as well as combinations thereof.

Embodiments of the invention may be implemented in a cellular communications network. In a cellular communications network, the area covered by the network is divided up into a plurality of cells or cell sectors. In general each cell or cell sector is served by a base station which arranged to communicate via an air interface (using radio frequencies for example) with user equipment in the respective cells. The user equipment can be mobile telephones, mobile stations, personal digital assistants, personal computers, laptop computers or the like. Any multi-user scheduling method can be used in conjunction with embodiments of the present invention to divide the resources (time, frequency, spreading codes etc.) between multiple users.

The transmitter may be a base station or user equipment and likewise the receiver may be a base station or user equipment.

It is also noted herein that while the above describes exemplifying embodiments of the invention, there are several variations and modifications which may be made to the disclosed solution without departing from the scope of the present invention as defined in the appended claims.

1. A communication system for transferring data between a transmitter and a receiver over a plurality of channels, the communication system comprising:
modulation circuitry having a plurality of modulation alphabets providing a set of bit loading sequences;
circuitry for determining a power allocation for at least one bit loading sequence based on minimizing an error rate; and
circuitry for selecting a bit loading sequence with a lowest error rate.

2. The communication system according to claim 1, wherein the plurality of channels comprises independent logical channels decomposed from a Multiple-Input, Multiple-Output channel.

3. The communication system according to claim 1, wherein the plurality of channels comprises independent logical channels decomposed from an orthogonal frequency division multiplexing channel.

4. The communication system according to claim 1, wherein the plurality of modulation alphabets is capable of representing data using a different number of bits.

5. The communication system according to claim 4, wherein for a fixed data rate a set of bit loading sequences is identified which specify a number of bits to be loaded on at least one channel of the plurality of channels.

6. The communication system according to claim 5, wherein the fixed data rate is selected based on a channel quality indicator.

7. The communication system according to claim 6, wherein the channel quality indicator is calculated at the transmitter.

8. The communication system according to claim 6, wherein the channel quality indicator is calculated at the receiver.

9. The communication system according to claim 1, wherein the determined power allocation provides a power weighting for at least one channel of the plurality of channels.

10. The communication system according to claim 9, wherein if an identical modulation alphabet is used for at least two logical channels then a greater power weighting is allocated to weaker logical channels.

11. The communication system according to claim 1, wherein a power allocation used to transfer the data comprises the power allocation determined for the at least one bit loading sequence.

12. The communication system according to claim 1, wherein the transmitter comprises a plurality of transmitting antennas.

13. The communication system according to claim 1, wherein the receiver comprises a plurality of receiving antennas.

14. The communication system according to claim 1, further comprising coding circuitry for adding parity bits to system bits and for distinguishing between the parity bits and the system bits.

15. The communication system according to claim 14, wherein the parity bits are transferred on a weak channel.

16. The communication system according to claim 14, wherein for a bit loading sequence having an identical modulation alphabet on at least two channels of the plurality of channels, the parity bits are transferred on at least one of a weakest channel and the power allocation is reduced.

17. A system according to claim 14, wherein for a bit loading sequence having different modulation alphabets on the plurality of channels, the parity bits are transferred in a least significant bits of a modulation alphabet used on a strong channel.

18. A method for transferring data between a transmitter and receiver over a communication channel, the method comprising:
identifying a set of bit loading sequences from a plurality of modulation alphabets;
determining a power allocation for at least one bit loading sequence based on minimizing an error rate; and
selecting a bit loading sequence with a lowest error rate and applying the power allocation to at least one communication channel.

19. A communication system for transferring data between a transmitter and receiver over a communication channel, the system comprising:
a first circuitry means for decomposing a communication channel into a plurality of logical channels;
modulation circuitry having a plurality of modulation alphabets, at least two modulation alphabets are capable of representing data using a different number of bits so that for a fixed data rate a set of bit loading sequences is identified which specify a number of bits to be loaded onto corresponding logical channels;
a second circuitry means for allocating a power weighting to the corresponding logical channels for minimizing a bit error rate of the identified bit loading sequences; and
a third circuitry for choosing a bit loading sequence having a minimum bit error rate.

20. A method for transferring data between a transmitter and receiver over a communication channel, the method comprising:
decomposing a communication channel into a plurality of logical channels;
selecting from a plurality of modulation alphabets, wherein at least two modulation alphabets for modulating data are capable of representing the data using a different number of bits;
identifying a set of bit loading sequences for a fixed data rate which specify a number of bits to be loaded onto corresponding logical channels of the plurality of channels;
allocating a power weighting to the corresponding logical channel for minimizing a bit error rate of corresponding bit loading sequences from the set of bit loading sequences; and
choosing a bit loading sequence having a minimum bit error rate.

21. A method according to claim 20, wherein the data to be transferred comprises systematic bits and parity bits, and wherein the parity bits are loaded onto weaker logical channels.

22. A communication system for transferring data between a transmitter and receiver over a communication channel, the system comprising:
decomposing means for decomposing a communication channel into a plurality of logical channels;
representing means for representing data using a different number of bits so that for a fixed data rate a set of bit loading sequences is identified which specify a number of bits to be loaded onto corresponding logical channels;
allocating means for allocating a power weighting to the corresponding logical channels for minimizing a bit error rate of the identified bit loading sequences; and
choosing means for choosing a bit loading sequence having a minimum bit error rate.

23. A communication system for transferring data between a transmitter and a receiver over a plurality of channels, the communication system comprising:
providing means for providing a modulation circuitry having a plurality of modulation alphabets and for providing a set of bit loading sequences;
determining means for determining a power allocation for at least one bit loading sequence based on minimizing an error rate; and
selecting means for selecting a bit loading sequence with a lowest error rate.
